(19) United States
(12) Patent Application Publication
(10) Pub. No.: US 2011/0270720 A1
(43) Pub. Date: Nov. 3, 2011

(54) Bank balance funds check and negative balance controls for enterprise resource planning systems

(75) Inventor: Jagadish Chandra Manohar, Toronto (CA)

(73) Assignee: MANOHAR ENTERPRISES, INC.

(21) Appl. No.: 13/135,618

(22) Filed: Jul. 11, 2011

Related U.S. Application Data
(63) Continuation-in-part of application No. 12/228,188, filed on Aug. 11, 2008, now abandoned.
(60) Provisional application No. 60/967,912, filed on Sep. 7, 2007.

(51) Int. Cl. G06Q 40/00

(52) U.S. Cl. 705/30

(57) ABSTRACT

A computer implemented method and system for providing automated controls for enterprise resource planning systems comprising a bank balance funds check control and a negative balance control. The bank balance funds check control checks the existing bank balance funds available, and validates a financial transaction on detecting adequate bank balance funds available, or prevents the validation of the financial transaction on detecting inadequate bank balance funds available, thereby preventing negative funds resulting out of outgoing payment, by way of restriction on the standard functionality of bank funds available fluctuating between positive and negative amounts. The negative balance control accepts and processes incoming positive and negative receipts, and manages the situation arising there out of, irrespective of availability of adequate bank balance funds available, resulting in negative bank funds or increase in the existing negative bank funds available, by way of context-sensitive exceptions to the restriction.

### CROSS REFERENCE TO RELATED APPLICATIONS

This application is a continuation-in-part application of non-provisional patent application Ser. No. 12/228,188 titled “Bank Balance Funds Check and Negative Balance Controls for Enterprise Resource Planning Systems”, filed on Aug. 11, 2008 in the United States Patent and Trademark Office, which claims the priority and benefit of provisional patent application No. 60/967,912 titled “Bank balance funds check and negative balance controls for ERP systems”, filed on Sep. 7, 2007 in the United States Patent and Trademark Office.

The specifications of the above referenced applications are incorporated herein by reference in their entirety.

### STATEMENT REGARDING FEDERALLY SPONSORED RESEARCH OR DEVELOPMENT

The subject of the disclosure given herein is not part of work done for the United States Government or any of its agencies. This is the applicant's original work that resulted during 2004-2007 when the applicant consulted the City of New York (NYC)'s human resources administration (HRA) on its Oracle financials reconfiguration project, through Adil Business Systems, Inc. (Adil). To the applicant's knowledge and understanding, the applicant might have signed non-disclosure-non-compete agreement with Adil but not signed any “work-made-for-hire” or equivalent agreement in favor of NYC, HRA or Adil.

### BACKGROUND

Oracle® E-Business Suite is an enterprise resource planning (ERP) applications suite owned by Oracle Corporation headquartered at Redwood Shores, Calif., and organized into a number of product areas like financials, manufacturing, project portfolio management, human resources, procurement, supply chain management, and customer relationship management, with each of these areas consisting of individual application modules. The financials area consists of the most used modules like general ledger, payables, receivables, assets, and cash management. Every sub ledger in an enterprise involving financial transactions post into the general ledger, wherein the general ledger is the sum total of all financial/accounting information. Adequate checks and controls are a must for any organization. While some controls reside in the general ledger, some reside in the appropriate sub ledgers. In cases where the controls reside in the general ledger, their impact may well transcend across the sub ledgers. The standard functionality of Oracle® Financials does not prevent writing checks when there are inadequate bank funds, in which case the books result in negative bank funds. Since checks cannot be issued with inadequate bank funds, the bank funds need to be manually checked each time a check is written to ensure that the transaction does not result in negative bank funds. This is very cumbersome, labor-intensive and risky, when multiple organization units, service areas, thousands of clients, bank accounts, large transaction volumes and frequent funds constraints are involved. To preclude this, many organizations maintain large bank funds or have an overdraft facility. All these involve various operating, financial and procedural costs.

Negative bank funds are not possible in an ideal theoretical scenario, as a payment cannot be made and a check should not be issued when there is no money in a bank account. However, in the course of average day-to-day transactions, negative bank funds occur all the time. Negative bank funds may arise in the following two ways: by way of outgoing payment against an invoice, and by way of incoming negative receipt, in the form of a debit memo or a credit memo. All organizations may not have incoming negative receipts. While the incoming negative receipts are non-controllable in the sense that the organization generally cannot control the inflow of debit/credit memos, the outgoing payments are controllable in the sense that the organization can holdback the payments for any reason including inadequate bank funds. Accordingly, organizations need to have the ability to not proceed with issuing checks for payments when the available bank funds is inadequate, thus preventing negative bank funds resulting out of an outgoing invoice payment, and at the same time allowing negative bank funds as a result of incoming negative receipt. From a practical control perspective, the best way to prevent the payment of an invoice is to perform a check before the transaction reaches the check writing stage.

Listed below are the prior arts identified by a prior art search:
1. Aggregated Postal Billing and Payment Methods and Systems: US 2004/0230523 A1.
2. Automated Banking Machine System and Method: US 2007/0235521 A1.
3. Electronic Financial Transaction System: US 2005/0171811 A1.
4. Methods, Devices and Systems for Electronic Bill Presentment and Payment: U.S. Pat. No. 6,578,015 B1.
5. Systems and Methods for Facilitating a Distribution of Bank Accounts via an Educational Institution: U.S. Pat. No. 7,249,096 B1.
6. System and Method for Offering Unsecured Consumer Credit Transactions: US 2004/0225545 A1.

As will be apparent after an examination of the above mentioned and other existing methods and systems, none of these provide organizations with the ability to withhold payments when the available bank funds are inadequate, preventing negative bank funds resulting from an outgoing invoice payment, and at the same time allowing negative bank funds as a result of an incoming negative receipt.

Hence, there is a long existing but unmet need for a computer implemented method and system that controls multiple enterprise transactions that impact bank funds by validating an enterprise transaction based on adequate bank funds for conducting the enterprise transaction.

There is also a need for a computer implemented method and system that processes a negative receipt, irrespective of availability of adequate bank funds.

There is also a need for a computer implemented method and system for conducting financial transactions involving receipt processing, irrespective of whether the receipt processing results in negative bank funds or an increase in existing negative bank funds.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated needs for controlling multiple financial transactions utilizing bank balance funds available (BBFA). The computer implemented system and method disclosed herein provides controls for validating the financial transactions performed through an enterprise resource planning (ERP) system. The bank balance funds available can either be the balance available in a single bank account, or a combined balance available in one or more bank accounts. One or more bank accounts may be assigned for conducting the financial transactions using the bank balance funds available. The financial transactions comprise, for example, processing an invoice, an incoming positive receipt, an incoming negative receipt, a journal, etc.

The computer implemented method and system disclosed herein comprises automated controls, namely, a bank balance funds check control and a negative balance control. The bank balance funds check control and the negative balance control are developed in addition to the standard functionality of the enterprise resource planning system. The bank balance funds check control checks the bank balance funds available before each financial transaction and validates the financial transaction only if the bank balance funds available (BBFA) is adequate. If the bank balance funds available (BBFA) is inadequate, the bank balance funds check control prevents validation of the financial transaction. Since only validated financial transactions can be processed, invoice type financial transactions that have not been validated do not reach a check writing stage, and as such, are not processed for payment. The bank balance funds check control prevents negative bank funds resulting out of an enterprise financial transaction if the bank balance funds available (BBFA) is insufficient for conducting the transaction. The term “negative bank funds” refers to negative bank balance funds available which is herein referred to as a “bank balance funds deficit”.

The negative balance control allows conducting a financial transaction, even if the financial transaction results in a negative bank balance funds deficit (BBFD), or in an increase in the existing negative bank balance funds deficit (BBFD). The computer implemented method and system disclosed herein is automated and avoids manual intervention that is otherwise needed for conducting the transactions in an enterprise resource planning system. The bank balance funds check control prevents a check being written against a financial transaction, for example, an invoice when the bank balance funds available (BBFA) is inadequate for processing the invoice. The negative balance control is used for allowing processing of a financial transaction irrespective of insufficient bank balance funds available (BBFA). For example, the negative balance control is specifically used for validating a financial transaction comprising processing of one or more of a negative receipt and a positive receipt, wherein the negative balance control validates the financial transaction even if the financial transaction results in a negative bank balance funds deficit (BBFD), or an increase in the existing negative bank balance funds deficit (BBFD).

In an embodiment of the computer implemented method and system disclosed herein, the standard ERP system functionality, for example, the standard Oracle® Financials functionality is built with the flexibility of bank balance funds available (BBFA) in one or more accounts fluctuating between positive and negative amounts. In another embodiment, the computer implemented method and system disclosed herein can be implemented on all the ERP systems to restrict such flexibility. While the bank balance funds check control is developed as a restriction on the standard flexibility, the negative balance control is developed as context-sensitive exceptions to the restriction. While it is theoretically possible to have the former implemented on a standalone basis, practical considerations show that both the bank balance funds check control and the negative balance control are needed in almost all cases. The negative balance control complements the bank balance funds check control, and the combined result is what is generally needed from an application user point of view. Implementing both the balance funds check control and the negative balance control is more complex than implementing one of the bank balance funds check control and the negative balance control for the ERP systems.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a comparative analysis of implementation of the standard functionality alone and the standard functionality in combination with a bank balance funds check control and a negative balance control in an enterprise.

FIG. 2 exemplarily illustrates effects of implementation of the standard functionality, the bank balance funds check control and the negative balance control through a conceptual diagrammatic representation of the implementation.

FIG. 3 illustrates providing additional accounting effects for invoices and receipts.

FIG. 4 exemplarily illustrates a block diagram of the bank balance funds check control and the negative balance control implemented within an enterprise resource planning system.

FIGS. 5A-5C exemplarily illustrate a process flow diagram of the method disclosed herein.

FIG. 6A exemplarily illustrates a customized solution with the bank balance funds check control and the negative balance control for invoices: distribution account expense or prepayment.

FIG. 6B exemplarily illustrates a customized solution with the bank balance funds check control and the negative balance control for invoices: distribution account revenue.

FIG. 7A exemplarily illustrates a customized solution with the bank balance funds check control and the negative balance control for receipts: scenarios 1.1, 1.21 and 1.22.

FIG. 7B exemplarily illustrates a customized solution with the bank balance funds check control and the negative balance control for receipts: scenarios 2.1, 2.21 and 2.22.

FIG. 8 exemplarily illustrates in brief the results of implementation of the standard functionality and implementation of the bank balance funds check control and the negative balance control.

FIG. 9 exemplarily illustrates a screenshot displaying referencing of a transaction code in a receipts window of accounts receivable (AR) during a transaction entry.

FIGS. 10-11 exemplarily illustrate referencing a transaction code in an accounts payable (AP) invoices window and an AP distributions window respectively.

FIGS. 12-16 exemplarily illustrate screenshots displaying journal entries for receipt scenarios 1.1, 1.21, 1.22, 2.1, and 2.2 respectively.

FIG. 17 exemplarily illustrates processing of transactions in a bank account.

FIG. 18 exemplarily illustrates an enterprise resource planning system for validating a financial transaction based on bank balance funds available (BBFA) in one or more bank accounts.

FIG. 19 exemplarily illustrates the architecture of a computer system or a server system employed for an enterprise resource planning system.

FIG. 20 exemplarily illustrates the implementation and results of the bank balance funds check control and the negative balance control in credit and prepaid situations.

### DETAILED DESCRIPTION OF THE INVENTION

An objective of the computer implemented method and system disclosed herein is that a financial transaction should not be conducted if the bank balance funds available (BBFA) is inadequate for conducting the financial transaction. The financial transaction, for example, an invoice should not be paid if the bank balance funds available (combined uncommitted balance) in all applicable general purpose bank accounts is less than an invoice amount. The bank balance funds available (BBFA) can either be a balance available in a single bank account, or a combined balance available in multiple applicable general purpose bank accounts. The multiple applicable general purpose bank accounts are, for example, savings, checking 1, and checking 2. The bank balance funds available (BBFA) refers to the combined uncommitted balance available in accounts such as savings, checking 1, and checking 2 for conducting enterprise financial transactions. The combined uncommitted balance represents funds that are not already reserved and are available for conducting any future transactions.

Another objective of the computer implemented method and system disclosed herein is that a financial transaction, for example, an invoice payment should be capable of being processed notwithstanding the availability of an adequate balance in a designated payment account, for example, checking 2, provided adequate bank balance funds are available. Payment of the invoice amount notwithstanding the availability of adequate funds in the payment account avoids the need for transferring an amount sufficient to cover the payment of the invoice payment amount to the designated payment account from other accounts if the balance in the designated payment account is not adequate but there is an adequate bank balance funds available (BBFA). These objectives are achieved by implementing a bank balance funds check control (BBFCC). The bank balance funds check control (BBFCC) achieves this objective by implementing a restriction on the standard flexible functionality of an enterprise resource planning (ERP) system.

Another objective of the computer implemented method and system disclosed herein is conducting a financial transaction, for example, processing incoming receipts by the system even if a negative receipt were to result in a negative bank balance funds deficit (BBFD), or an increase in the existing negative bank balance funds deficit (BBFD). This is achieved by a negative balance control. The negative balance control achieves this by implementing context-sensitive exceptions to the restriction presented by the bank balance check control. The term “negative bank funds” refers to negative bank balance funds available, herein referred to as a “bank balance funds deficit” (BBFD).

The bank balance funds check control (BBFCC) and the negative balance control are achieved by combining a number of financial, accounting and systems development principles, disparate standard application features, and custom programming, through a complex design, in a unique way, to achieve this unique, non-standard, high value, critical user need. The accounting principles comprise, for example, a double entry system of bookkeeping, journal entry, budgeting, budgetary controls, funds check, and encumbrance.

The computer implemented method and system disclosed herein have been developed by way of automated additional accounting effects, of normal financial transactions performed by a user like invoice and receipt processing, in a way the system performs a normal user task as usual, and at the same time, creates an additional accounting effect or effects, as needed, depending on the details of the bank balance funds available and an incoming financial transaction of the user. Controls are applied on custom-developed components of an additional accounting effect, which in turn, triggers an appropriate preventive control on the concerned financial transaction of the user in the case of an invoice before the financial transaction takes place or allows the financial transaction as a context-sensitive exception to the restriction in the case of a receipt. Control is exercised at the invoice validation stage before the invoice can be selected for payment in a subsequent payment stage.

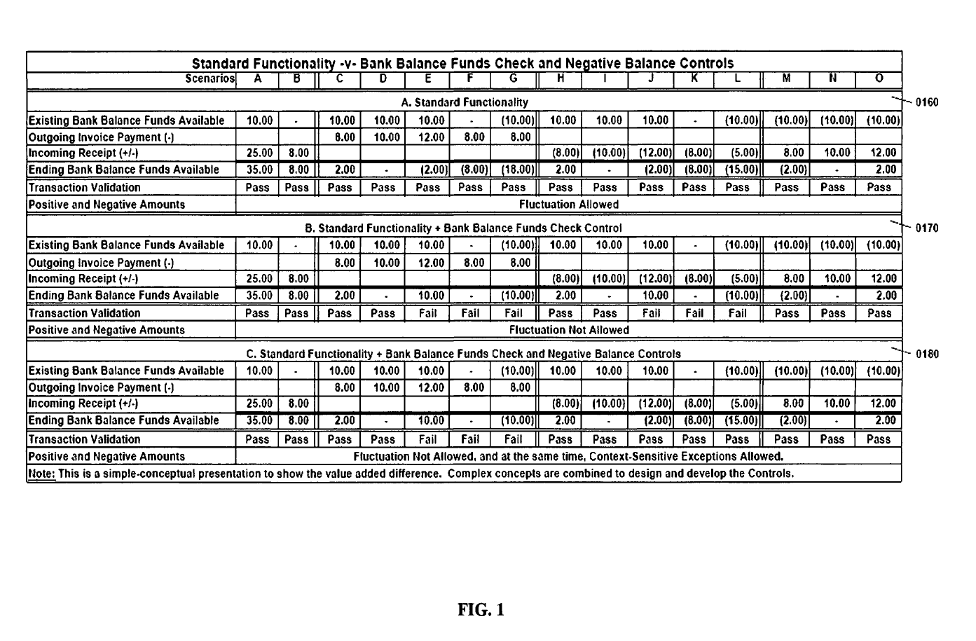

FIG. 1 exemplarily illustrates a comparative analysis of implementation of the standard functionality 0160 currently followed and the standard functionality in combination with a bank balance funds check control 0170, and the standard functionality in combination with the bank balance funds check control and a negative balance control 0180 in an enterprise. Numerals within parenthesis represent negative values and numerals without parenthesis represent positive values. The standard functionality 0160 validates a financial transaction irrespective of adequate bank balance funds available. The standard functionality and the bank balance funds check control combination 0170 validates the financial transaction if the bank balance funds available (BBFA) is sufficient for validating the financial transaction. The financial transaction is, for example, an outgoing invoice payment, an incoming positive receipt, an incoming negative receipt, a journal, etc. The incoming positive receipt is always validated because the incoming positive receipt increases the bank balance funds available. The standard functionality, the bank balance funds check control and the negative balance control combination 0180 validates the outgoing invoice payment only if the bank funds available (BBFA) are adequate. The standard functionality, the bank balance funds check control and the negative balance control combination 0180 validate the incoming negative receipt irrespective of adequate bank balance funds available for processing the negative receipt.

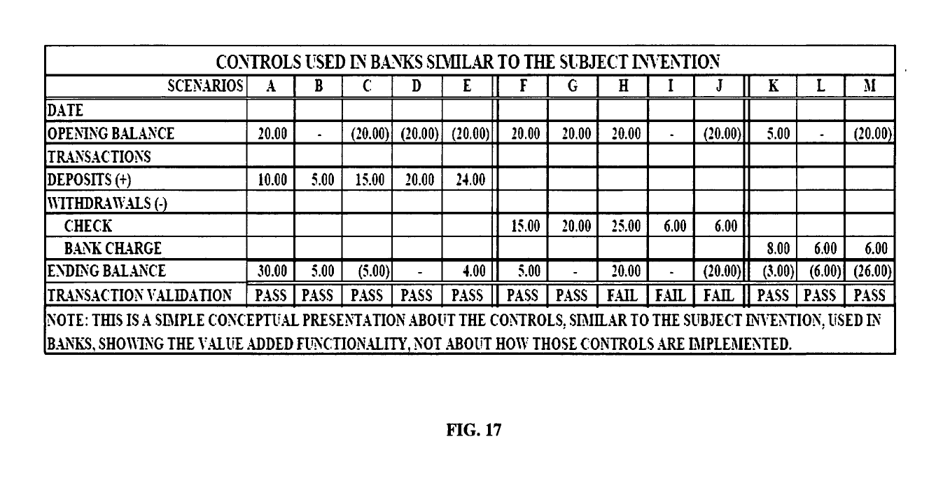

FIG. 17 exemplarily illustrates a conceptual presentation of processing transactions in a bank account including how a bank charge is processed in the absence of adequate balance in the bank account. The bank account, for example, is a checking 2 account. At present, when the existing balance, that is, the opening balance in the bank account is less than a check amount, an automated system of the bank prevents the negative bank balance funds deficit (BBFD) in the bank account by preventing payment of the check. Columns F, G, H, I, and J of FIG. 17 illustrate scenarios where an automated system of the bank rejects processing of the checks that result in negative bank balance funds deficit (BBFD), or in an increase in the negative bank balance funds in the bank account. In several other scenarios, when a transaction involves processing a bank charge, the transaction is performed regardless of the increase in the negative bank balance funds deficit (BBFD) in the bank account. Columns K, L and M illustrate scenarios where a bank charge is processed even if the bank charge results in or increases the existing negative bank balance funds deficit (BBFD) in the bank account.

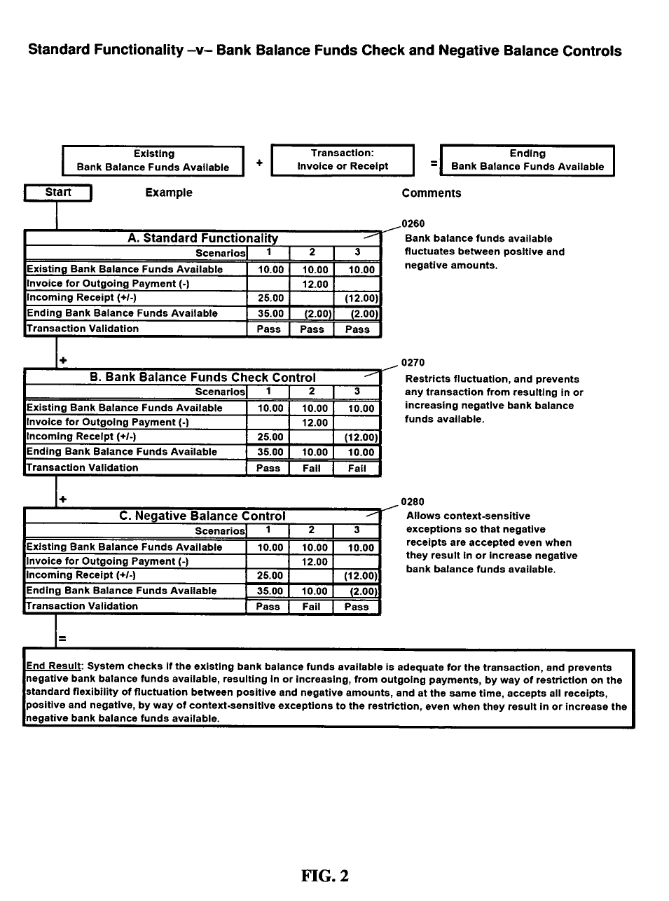

FIG. 2 exemplarily illustrates effects of implementation of the standard functionality 0260, the bank balance funds check control 0270, and the negative balance control 0280 through a conceptual diagrammatic representation of the implementation. As illustrated in FIG. 2, the bank balance funds available fluctuates between a positive and a negative amount during implementation of the standard functionality alone 0260 as conventionally done. A combined implementation of the standard functionality and the bank balance funds check control 0270 restricts the fluctuation of the bank balance funds and prevents financial transactions that result in or increase the negative bank balance funds deficit (BBFD). A combined implementation of the standard functionality 0260, the bank balance funds check control 0270 and the negative balance control 0280 allows context sensitive exceptions for acceptance of the financial transactions resulting in an increase in the existing negative bank balance funds deficit (BBFD). The financial transactions for which the negative balance control 0280 allows context sensitive exceptions comprise processing negative and positive receipts.

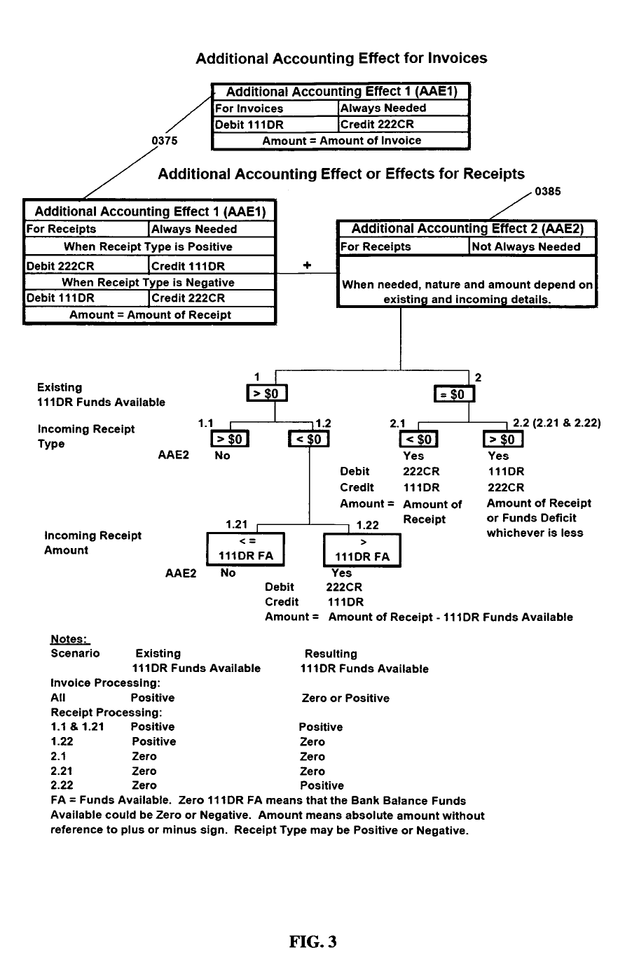

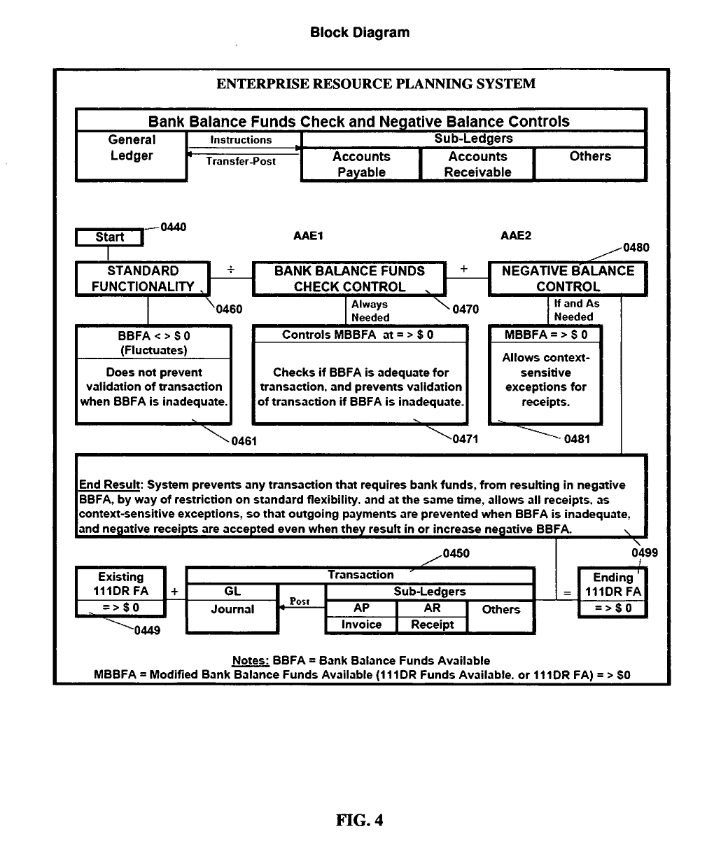

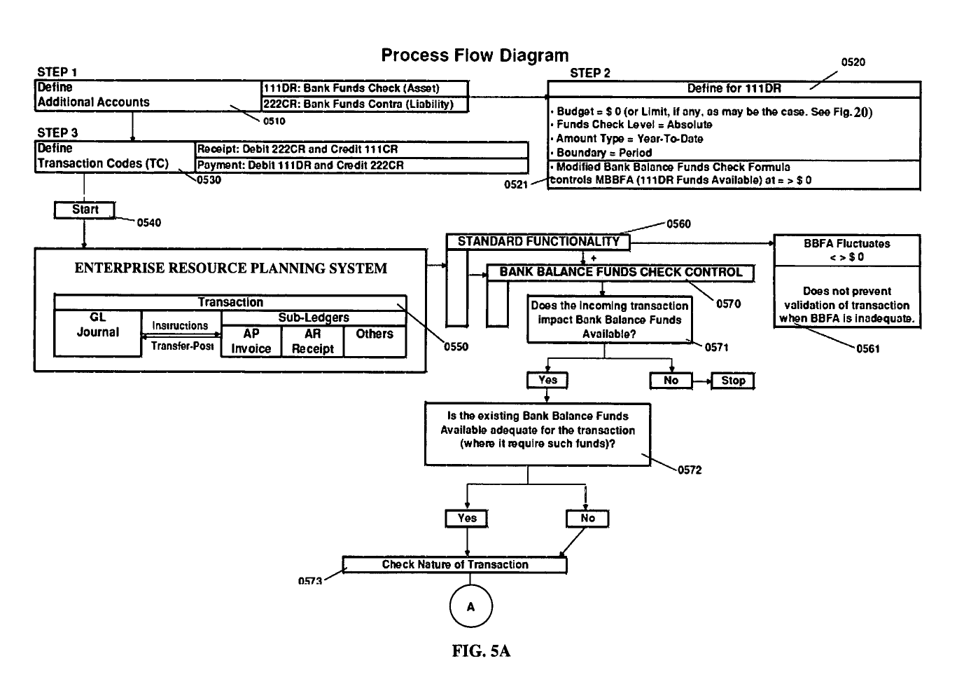

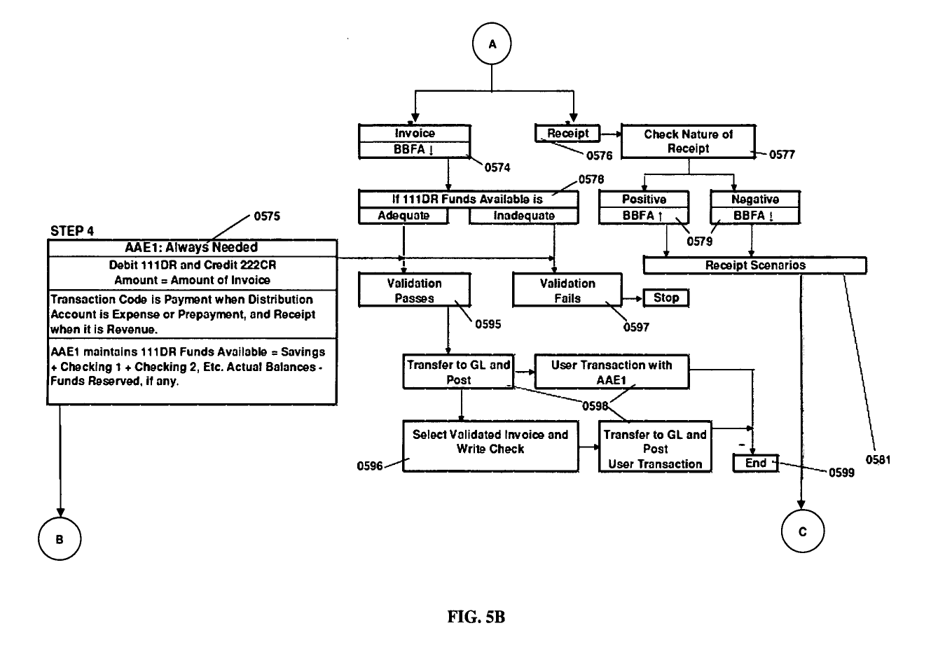

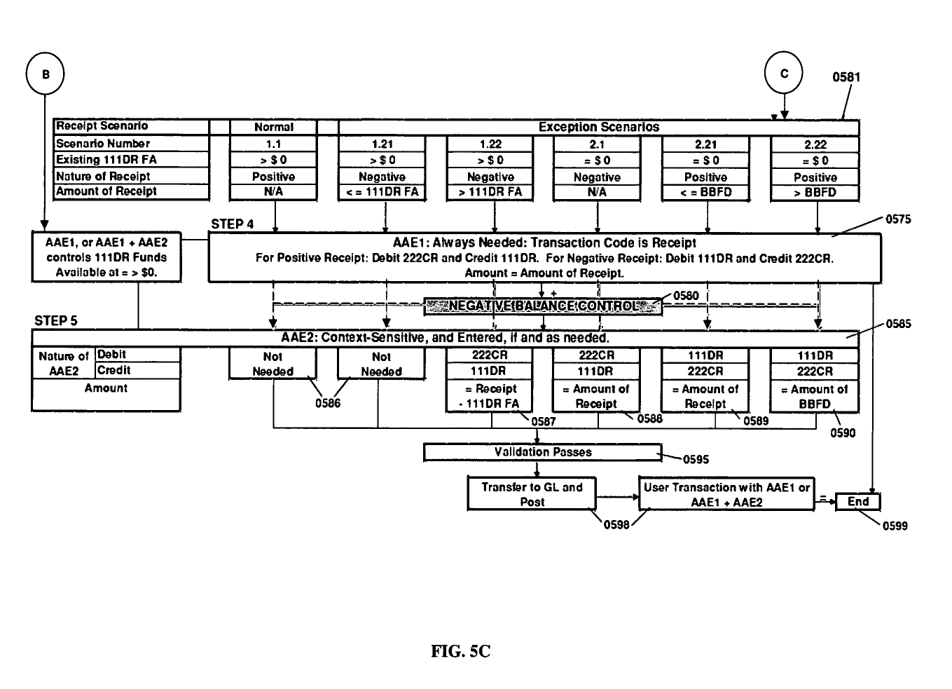

FIG. 3 illustrates providing additional accounting effects for invoices and receipts. FIG. 4 exemplarily illustrates a block diagram of the bank balance funds check control 0470 and the negative balance control 0480 implemented within an enterprise resource planning (ERP) system. FIGS. 5A-5C exemplarily illustrate a process flow diagram of the method disclosed herein. As exemplarily illustrated in FIG. 5A-5C, the computer implemented method disclosed herein is implemented in five main steps as given below.

Step 1: Creating Additional Accounts

A pair of additional (non-user-used) accounts are created 0510. 5-digits are used to represent each account in this example. These additional accounts are:
a. a first additional account: 111DR bank funds check, defined as asset, debit balance normally; and
b. a second additional account: 222CR bank funds contra, defined as liability, credit balance normally.

The first and second additional accounts 111DR and 222CR are created to meet the requirements of a double entry system of bookkeeping. The bank balance funds check control 0570 and the negative balance control 0580 are applied on the 111DR and 222CR additional accounts.

Step 2: Definitions for 111DR Additional Account

A $0 budget amount is entered for the 111DR additional account for all periods. The following budgetary controls are defined 0520 for the 111DR additional account:
Budget: Entered;
Bank funds check level: Absolute;
Amount type: Year-To-Date (YTD); and
Boundary: Period.

For a particular account combination, the system will presume $0 budget when no budget amount is entered. The budgetary control absolute implies that the financial transaction 0450 must always pass the funds check test. Else, the financial transaction 0450 fails. Amount type of YTD and boundary of period are suitable when a yearly calendar is used with monthly periods.

The computer implemented method and system disclosed herein provides automated controls 0570 and 0580 for an enterprise resource planning system as disclosed above. The automated controls 0570 and 0580 validate a financial transaction based on the bank balance funds available in the bank accounts. The bank accounts are, for example, general purpose bank accounts comprising a checking 1 account, a checking 2 account, a savings account, etc. The automated controls 0570 and 0580 provided by the computer implemented system disclosed herein comprise:
a. The bank balance funds check control 0470 and 0570; and
b. The negative balance control 0480 and 0580.

The Oracle® standard functionality 0460 and 0560 uses the following formula for determining the funds available in an account:

Funds available in an account=budget−(actual+encumbrance).

In contrast, the bank balance funds check control 0570 and the negative balance controls 0580 use a two-part modified bank balance funds check formula 0521 for the 111DR additional account, to maintain the 111DR funds available=>$0:
a. When the difference between the combined actual balance available in the savings, checking 1 and checking 2 accounts and the combined funds reserved in the savings, checking 1 and checking 2 accounts is greater than zero, the bank balance funds available is equal to the difference between the actual balance and funds reserved. Given below is a two-part modified bank balance funds check formula (111DR bank funds available) for the 111DR additional account when the difference is greater than zero:

Savings+checking 1+checking 2 actual balances−funds reserved pending payment, if any, is >$0:

Bank balance funds available (111dr bank funds available)=savings+checking 1+checking 2 actual balances−funds reserved, if any; and
b. When the difference between the combined actual balance available in the savings, checking 1 and checking 2 accounts and the combined funds reserved in the savings, checking 1 and checking 2 accounts is less than or equal to zero as shown below, the bank funds available is zero:

Savings+checking 1+checking 2, etc. actual balances−funds reserved, pending payment, if any, is <=$0:

Bank balance funds available (111dr bank funds available)=0.

Step 3: Transaction Codes or Account Code Pairs

A pair of transaction codes, namely, “Receipt” and “Payment”, is created 0530 and additional accounts are attached to each of the transaction codes. The additional accounts are attached to the transaction codes as follows:
a. Receipt: Debit 222CR and credit 111DR
b. Payment: Debit 111DR and credit 222CR

The bank balance funds check control 0470 and 0570 and negative balance control 0480 and 0580 deal with financial transactions 0450 that affect the bank balance funds available. Financial transactions 0450 involving receipts and invoices, that increase or decrease the bank balance funds available normally originate in accounts receivable (AR) and accounts payable (AP) 0550. After being validated, the financial transactions 0450 are transferred to and posted in the general ledger (GL). The standard functionality 0460 of the ERP Systems is built with the flexibility of account balances and allows bank funds available to fluctuate between positive and negative amounts, and does not prevent writing a check when the bank funds available are inadequate 0461 and 0561. As against this, the bank balance funds check control 0470 presents a restriction 0499 in case of all financial transactions 0450 that impact the bank balance funds available 0571. The bank balance funds check control 0470 and 0570 presents the restriction by way of checking to see if the existing bank balance funds available (BBFA) are adequate 0572 for the financial transaction 0450 being conducted. Depending on the nature of the transaction 0573, the bank balance funds check control 0470 validates 0595 an invoice 0574 if adequate bank balance funds are available 0578, which is then selected for writing a check 0596. The bank balance funds check control 0470 and 0570 prevents validation 0597 of the invoice when the bank balance funds available are inadequate 0471, by way of restriction on the standard flexible functionality of the ERP system.

The negative balance control 0580 is used for controlling processing of receipts 0576. The negative balance control 0580 validates 0499 all receipts 0577, even when the validated negative receipts result in a negative bank balance funds deficit (BBFD) or in increase in an existing negative bank balance funds deficit (BBFD). The negative balance control 0580 validates the receipts, by way of context-sensitive exceptions to the restriction 0481 and 0581.

The bank balance funds check control 0470 and 0570 and the negative balance control 0480 and 0580 validate financial transaction 0450, if the financial transaction 0450 increases the bank balance funds available. For example, the bank balance funds check control 0470 and 0570 and the negative balance control 0480 and 0580 validate an incoming positive receipt since the positive receipt increases the bank balance funds available 0579.

Step 4: Additional Accounting Effect 1 (AAE1)

Each time a transaction such as a GL journal, an AP invoice or an AR receipt having an impact on the bank balance funds available is processed, the appropriate transaction code (receipt or payment) is automatically referenced in the financial transaction 0450 of the user, depending on the additional accounting effect required.

Whenever a financial transaction 0450 increases the bank funds available, an equal credit to 111DR (and Debit to 222CR) is entered. Example: Opening balances and receipts (positive amounts).

Whenever a financial transaction 0450 decreases the bank balance funds available, we enter an equal debit to the 111DR and credit to 222CR. Example: Invoices for outgoing payments, and receipts (negative amount).

From a user perspective, “bank balance funds available” means bank funds available to the extent not reserved on any other transaction, with reference to a particular organizational entity (client in the example used). In the Oracle® financials system, “funds available” means “budget—(actual+encumbrance)” with reference to a particular account combination.

Additional accounting effect 1 (AAE1) 0375 is used to prevent validation of an invoice when the bank funds available are inadequate. AAE1 0375 is referenced during every financial transaction 0575. The amount of the AAE1 0375 is always equal to the amount of the client-specific user transaction 0450. Every user-specific financial transaction 0450 that increases or reduces the bank balance funds available will reference the appropriate transaction code as follows:
a. In the general ledger: During a journal entry: At the line level for the required lines.
   i. “Receipt” when the transaction increases the bank balance funds available.
   ii. ‘Payment’ when the transaction reduces the bank balance funds available.
b. In payables: During an invoice entry: At the header level for the entire invoice.
   i. “Payment” for invoices where all the distribution accounts of the invoice are expense accounts.
   ii. “Receipt” for all invoices where all the distribution accounts of the invoice are revenue accounts.
   iii. In the event some of the distribution lines are expense accounts and some are revenue accounts in the same invoice (very rare, or almost not there in reality), then in such cases, the appropriate transaction codes are referenced on each of the distribution lines on the distributions window, as needed, not in the invoice header. When the transaction code is referenced in the invoice header block, transaction code defaults to all the distribution lines in the distributions window, where transaction code can be changed, if and as needed.
c. In receivables: During a receipt entry: At the header level for the entire receipt. “Receipt” for all receipts, both positive and negative amount receipts.
d. Referencing the transaction code at the batch header is not advised whether for GL journal, the AP invoice or the AR receipt.
e. The system and method disclosed herein automatically generates additional accounting effect 1 (AAE1) when an appropriate transaction code is referenced in the user transaction 0450, used in combination with AAE2 for processing of receipts.
f. None of the transaction codes should be referenced in financial transactions 0450 that do not increase or reduce the bank balance funds available. For example: Transfer from one bank account to another, for example, from savings to checking 2.
g. In case of receipts, we reference the “Receipt” transaction code. The system generates the AAE1 (credit or debit 111DR), as needed, depending on whether the incoming receipt is positive or negative 0577.

In an embodiment, the first and second additional accounts 111DR and 222CR and the transaction codes “Receipt” and “Payment” follow a different nomenclature. In another embodiment, the nomenclature does not describe what the codes do.

Step 5: Additional Accounting Effect 2 (AAE2):

Additional accounting effect 2 (AAE2) 0385 is used to allow processing of negative receipts even when they result in a negative bank balance funds deficit (BBFD) or an increase in the existing negative bank balance funds deficit (BBFD). The AAE2 0385 is not always needed 0585. When needed, AAE2 0385 is used in addition to AAE1 0375, to allow negative bank balance funds deficit (BBFD) and manage the situation arising there out of, in conjunction with the ability to prevent validation of an invoice when the bank funds (combined uncommitted balance) are less than the invoice amount. Whether AAE2 0385 is needed or not, as well as whether the nature and amount of the AAE2 0385 are context based, and when needed, the amount is calculated depending on the existing and incoming criteria, as applicable, per scenarios 0581 discussed below:
a. Scenario 1.1: If the existing 111DR bank funds available (bank balance funds available) 0449 is positive (>$0) and the incoming receipt is positive (>$0): Additional accounting effect 2 0385: Not needed 0586.
b. Scenario 1.21: If the existing 111DR bank funds available (Bank balance funds available) 0449 is positive (>$0), the incoming receipt is negative (<$0) and the amount of the incoming negative receipt is <=Existing 111DR bank funds available: Additional accounting effect 2 (AAE2) 0385: Not needed 0586.
c. Scenario 1.22: If the existing 111DR bank funds available (bank balance funds available) 0449 is positive (>$0), the incoming receipt is negative (<$0), and the amount of the incoming negative receipt is >existing 111DR bank funds available (Bank balance funds available): Additional accounting effect 2 (AAE2) 0385: Debit 222CR and credit 111DR, equal in amount, to the amount of incoming negative receipt less existing 111DR bank funds available 0587.
d. Scenario 2.1: If the Existing 111DR bank funds available (bank balance funds available) 0449 is =$0 and the incoming receipt is negative (<$0): Additional accounting effect 2 (AAE2) 0385: Debit 222CR and credit 111DR, equal in amount, to the amount of the incoming negative receipt 0588.
e. Scenario 2.2: If the existing 111DR funds available (bank balance funds available) 0449 is =$0 and the incoming receipt is positive (>$0): Additional accounting effect 2 (AAE2) 0385: Debit 111DR and credit 222CR, equal in amount, to the amount of the incoming receipt or existing funds deficit, whichever is less 0589 and 0590. The existing funds deficit is the negative bank balance funds available, herein referred to a bank balance funds deficit (BBFD)
f. For the purpose of better understanding, FIG. 7B illustrates, scenario 2.2 with two sub-scenarios 2.21 and 2.22.

Financial transactions 0450 leading to increase or decrease in the bank balance funds available, originating in any sub ledger other than payables and receivables need the additional accounting effects as described herein. Payables and receivables windows of the mother application include a provision to reference transaction code and enter additional accounting effect 2. The additional accounting effect 1 and additional accounting effect 2 are directly entered in the general ledger for originating sub ledger or the ERP system devoid of provision to reference transaction code and enter additional accounting effect 2. The additional accounting effects are validated 0595 along with the financial transaction 0450. The validated financial transactions are transferred to and posted in the GL 0598.

Provisions for manual intervention are included for non-standard situations for implementing the computer implemented method and system disclosed herein.

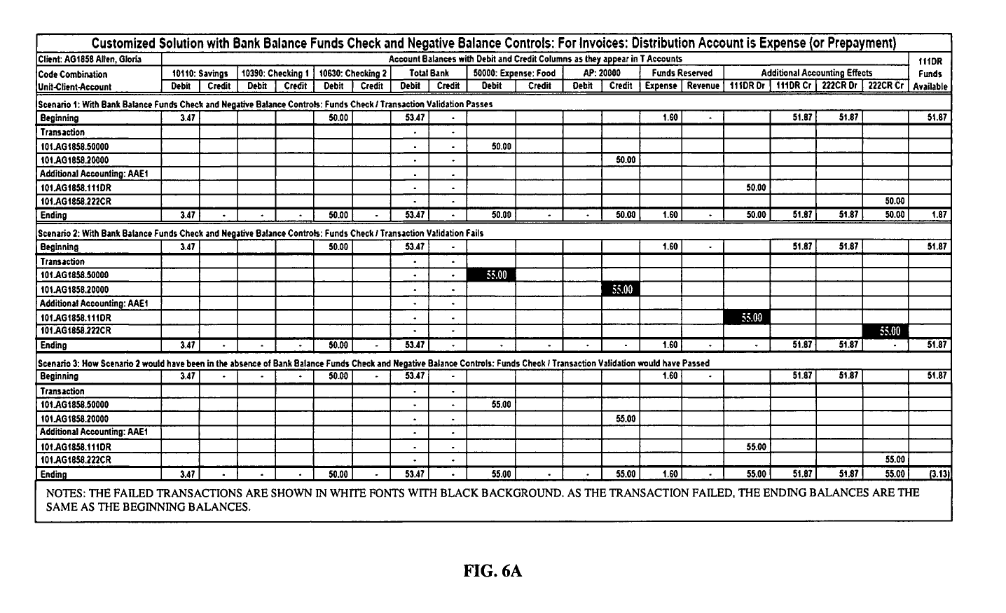

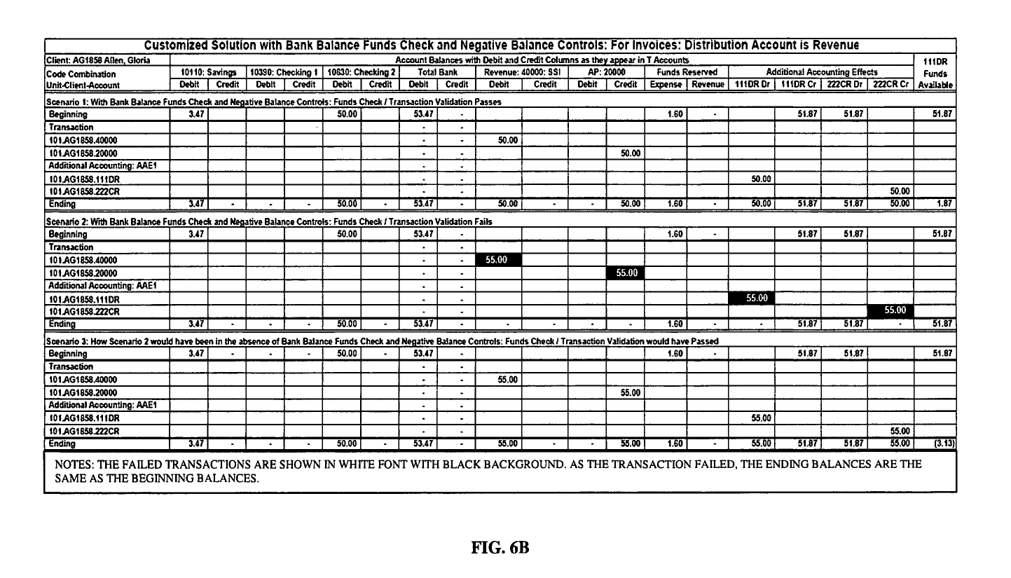

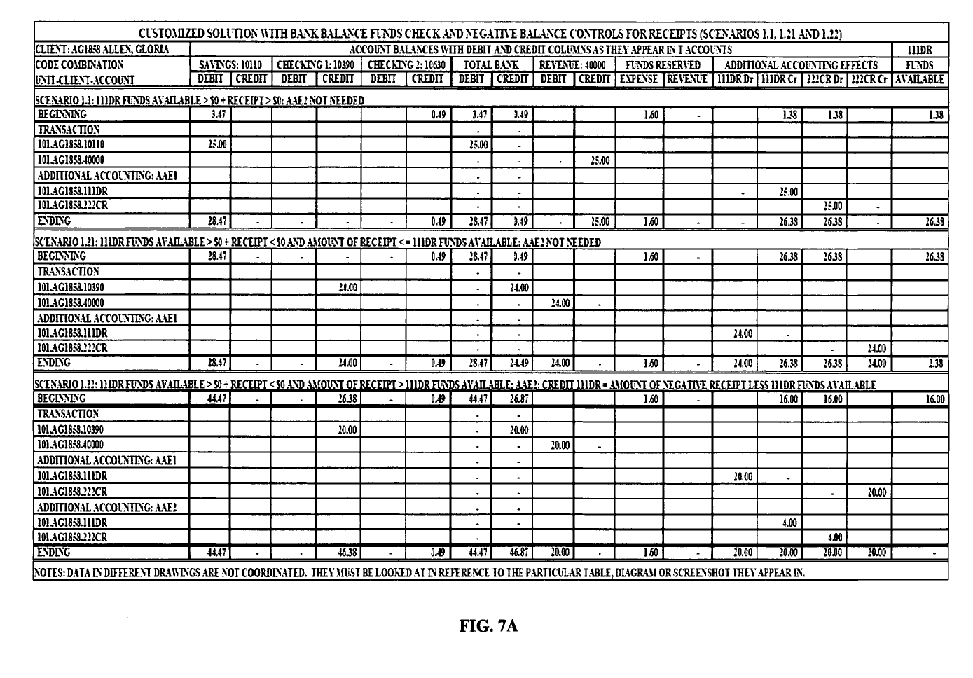

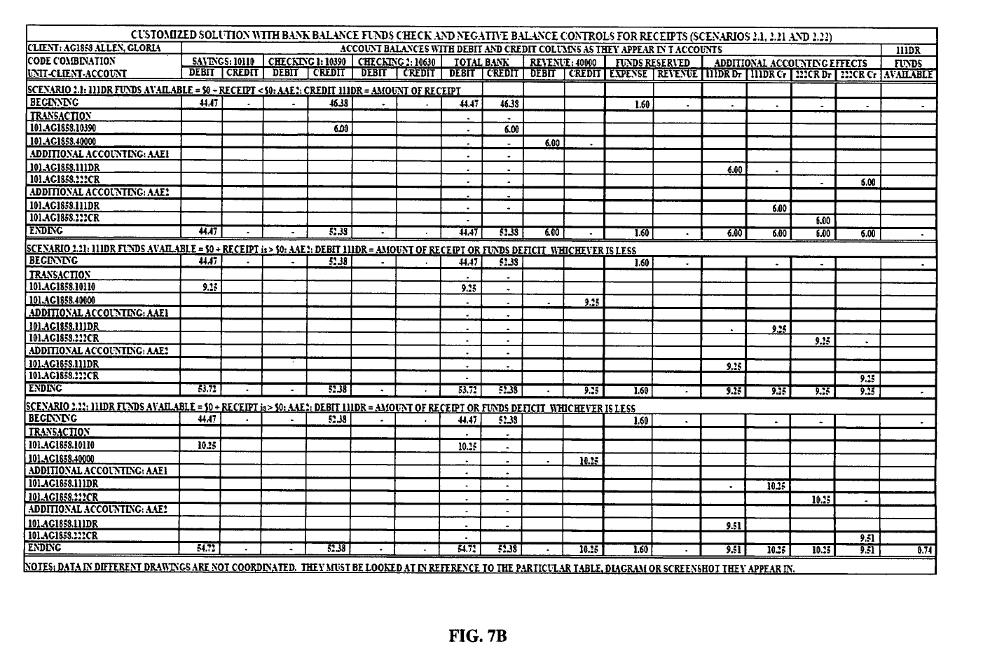

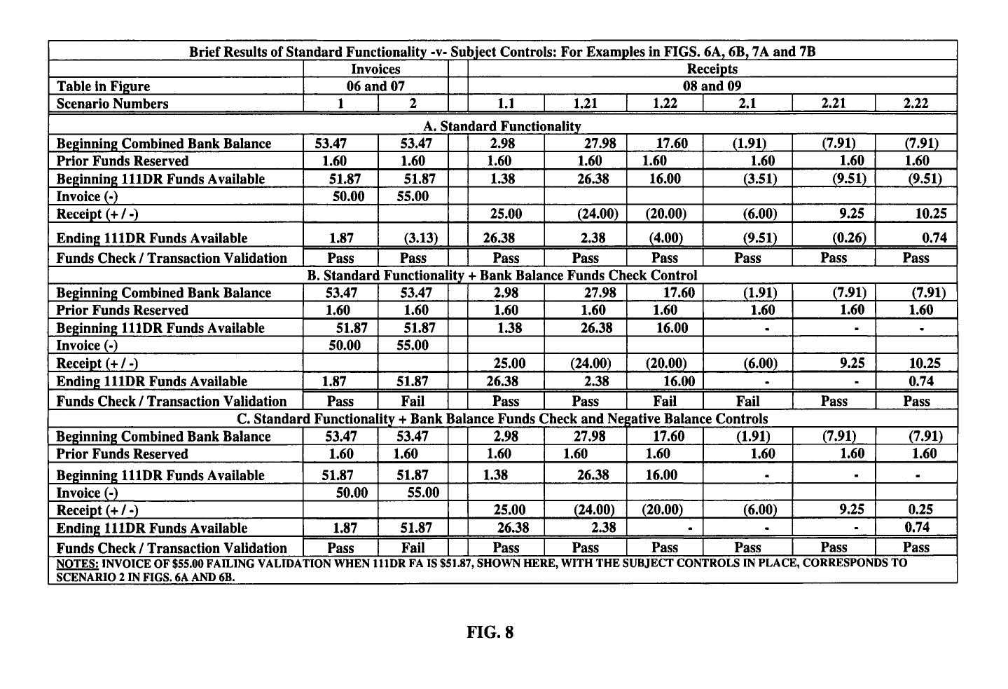

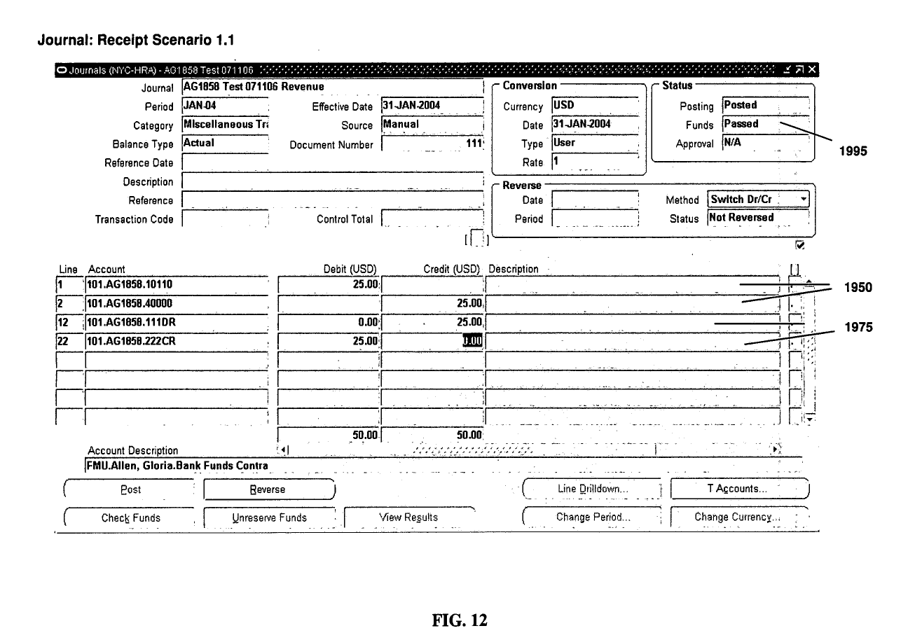

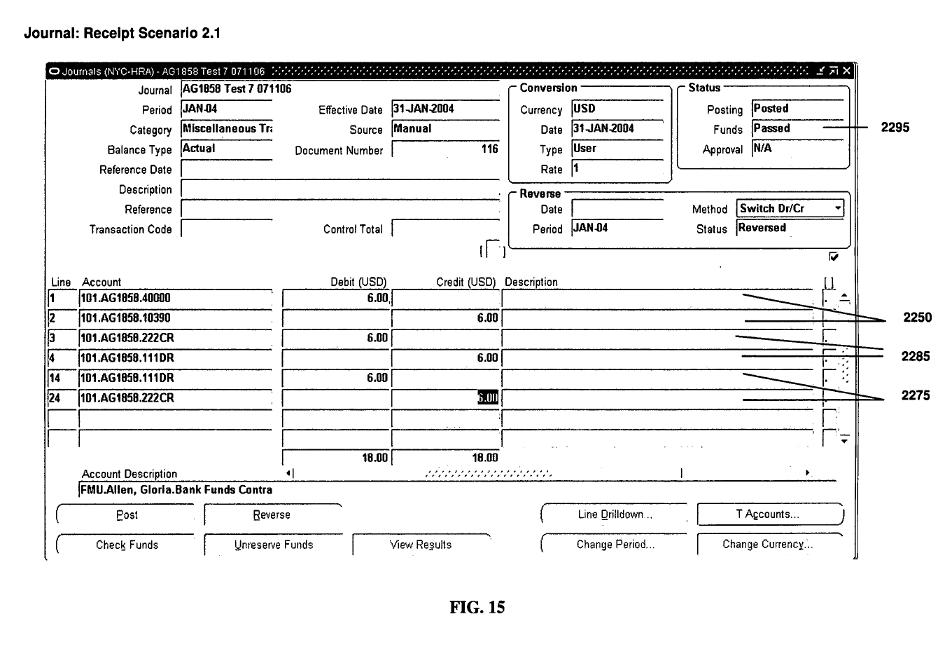

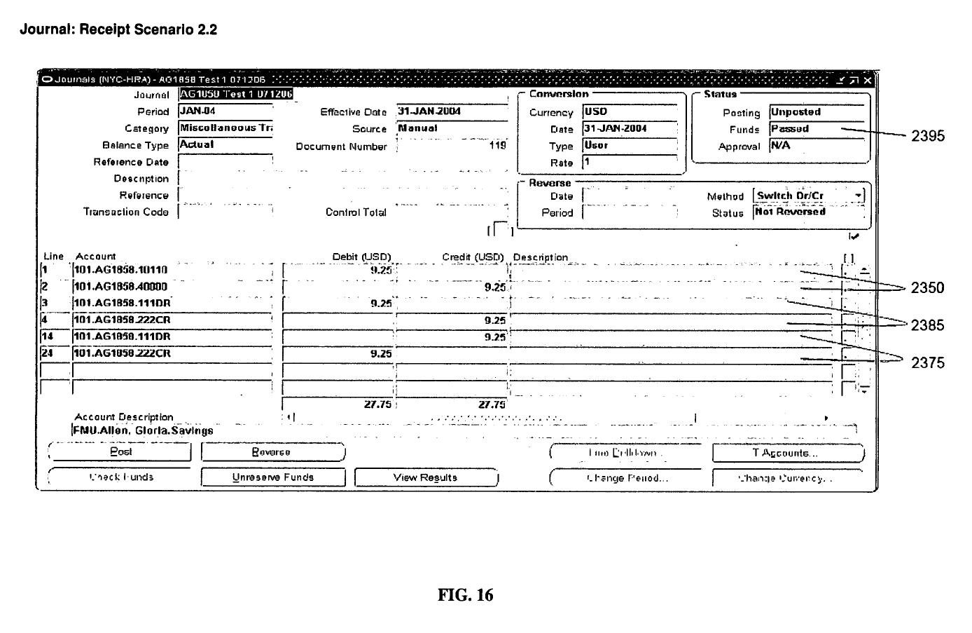

FIGS. 6A and 6B exemplarily illustrate customized solutions in relation to invoice processing. FIG. 6A illustrates a customized solution with the bank balance funds check control 0470 and 0570 and the negative balance control 0480 and 0580 for a distribution account including an expense account (or prepayment) and FIG. 6B exemplarily illustrates a customized solution with the bank balance funds check control 0470 and 0570 and the negative balance control 0480 and 0580 for a distribution account including a revenue account. FIGS. 7A and 7B exemplarily illustrate customized solutions with the bank balance funds check control 0470 and 0570 and the negative balance control 0480 and 0580 in relation to receipt processing. FIG. 7A exemplarily illustrates a customized solution in relation to receipt scenarios 1.1, 1.21 and 1.22 illustrated in FIGS. 12, 13, and 14 respectively and FIG. 7B exemplarily illustrates a customized solution in relation to receipt scenarios 2.1 and 2.2 illustrated in FIGS. 15 and 16 respectively.

FIG. 8 exemplarily illustrates in brief the results of implementation of the standard functionality in comparison to standard functionality and the subject controls, for example, 0470 and 0480. As a result of the subject controls, for example 0470 and 0480 namely: bank balance funds check control 0470 and 0570 and negative balance control 0480 and 0580, the 111DR funds available (bank balance funds available) in the first additional account (111DR) is always kept equal to the actual combined bank balance minus the funds reserved, if any, when the combined bank balance minus the funds reserved is positive, and to $0 when the combined bank balance minus the funds reserved, if any, is zero or negative. The controls, for example, 0470 and 0480 are so implemented that when fully automated, they work the same way irrespective of whether the financial transaction entry is done manually, or automated, and automatically trigger one or more of the additional accounting effects (AAE1 and AAE2) 0375 and 0385 for the GL journal, AP invoice and AR receipt entries. The combined practical result of the bank balance funds check and negative balance controls, for example, 0470 and 0480 working together is that the system prevents negative bank balance funds deficit (BBFD) resulting or increasing out of invoice payment, and at the same time, allows negative receipt even if the payment were to result in or increase the negative bank balance funds deficit (negative BBFD).

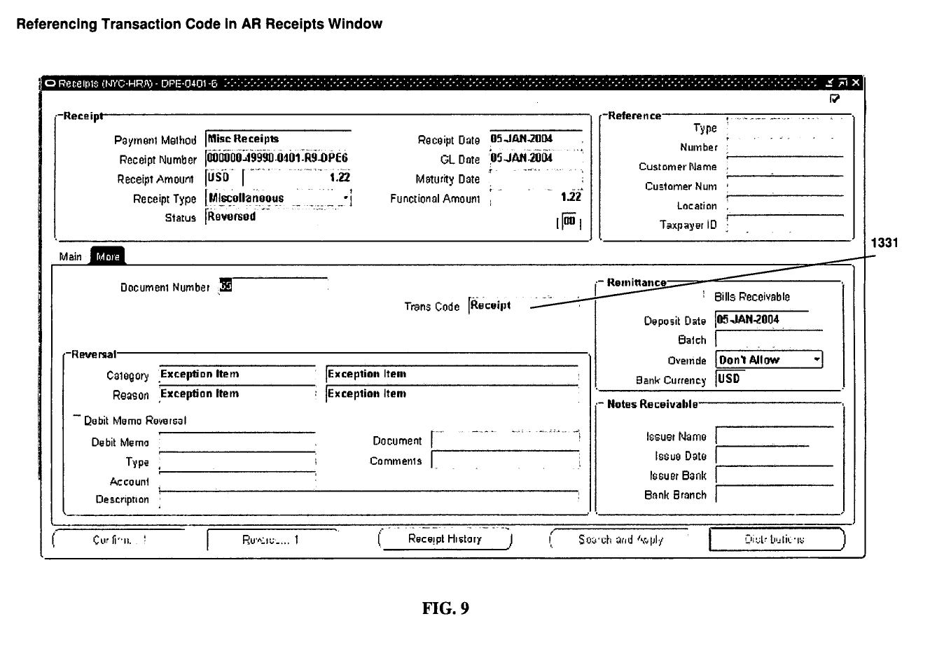

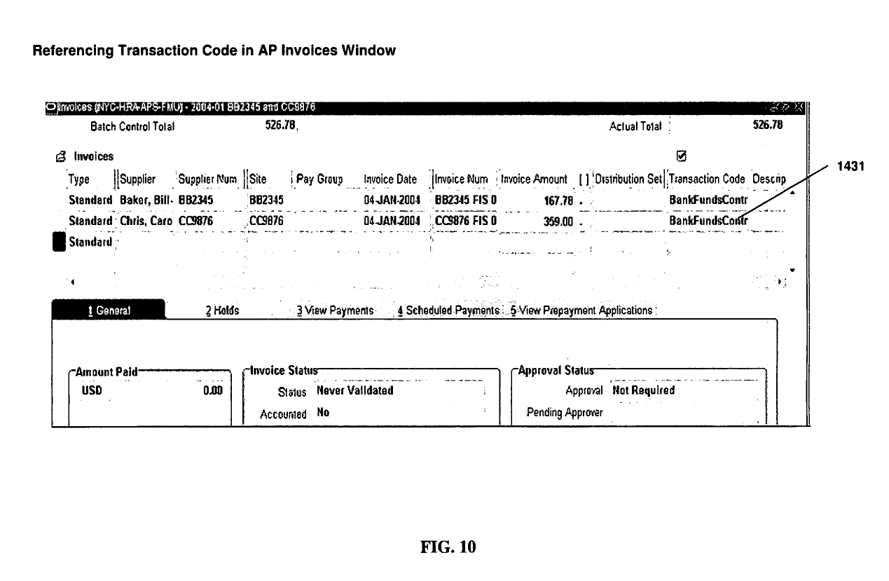

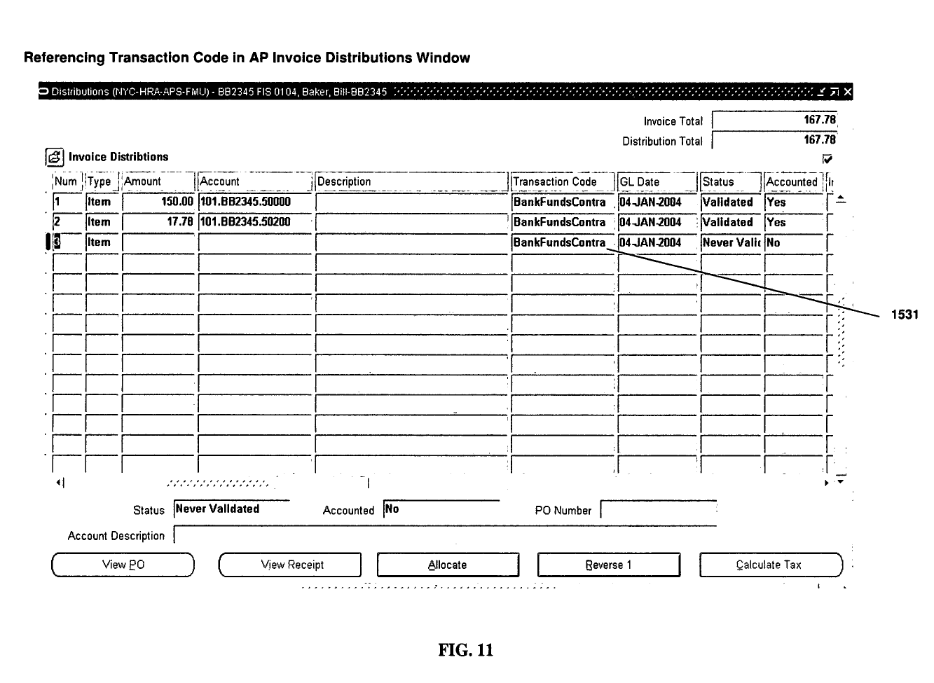

Screenshots, captured from the human resources administration (HRA) implementation, show with better visual effect, how the subject controls, for example, 0470 and 0480, as designed and implemented, work. FIG. 9 illustrates a screenshot displaying referencing of the appropriate transaction code in the receipts window 1331 of accounts receivable during transaction entry. FIG. 10 illustrates referencing appropriate transaction code in the invoices window 1431 of accounts payable during invoice entry. FIG. 11 illustrates referencing transaction code in the invoice distributions window 1531, for changing the transaction code as needed.

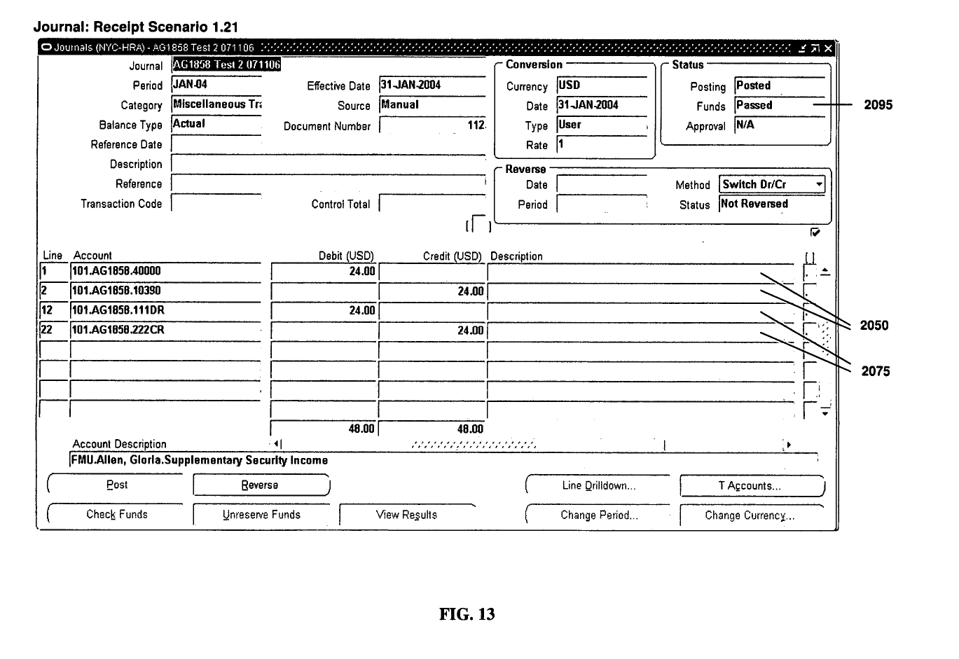

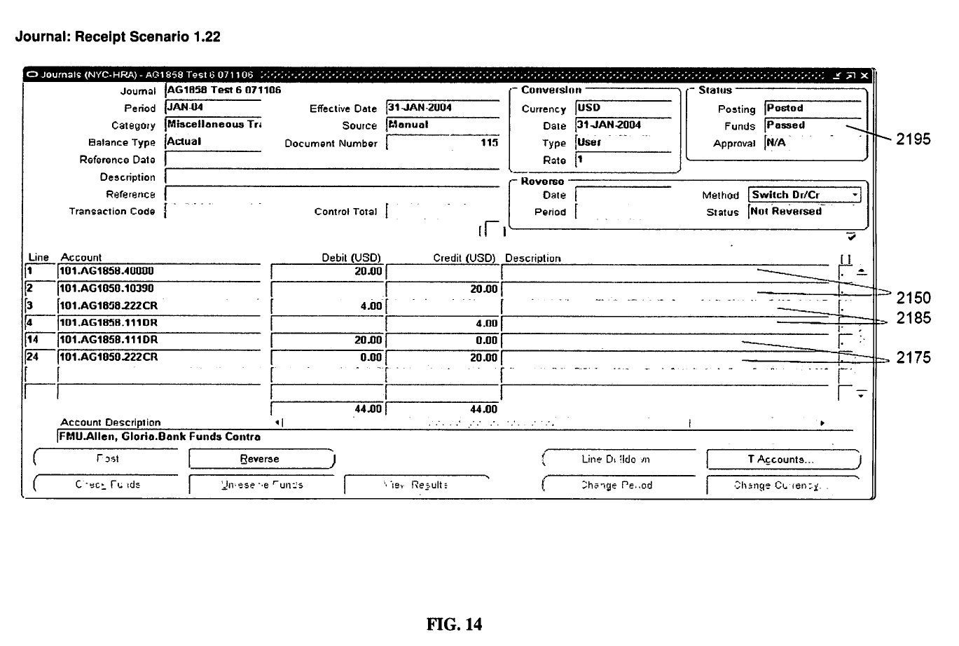

FIGS. 12-16 exemplarily illustrate screenshots displaying the journal entries generated by the automated controls, for example 0470 and 0480 for the receipt scenarios 1.1, 1.21, 1.22, 2.1 and 2.2 (2.21 and 2.22) respectively. The screenshots display the type of journal entry generated by the system, as appropriate, for each of the receipt scenarios with lines in the journal entry representing the financial transaction 0450 of the user 1950, 2050, 2150, 2250 and 2350 for receipt scenarios 1.1, 1.21, 1.22, 2.1 and 2.2 respectively, as well as lines representing the additional accounting effect 1 0375 and lines representing the additional accounting effect 2 0385. It is to be noted that while the receipt scenarios 1.1 and 1.21 have only additional accounting effect 1, receipt scenarios 1.22, 2.1 and 2.2 (2.21 and 2.22) have both additional accounting effects 1 and 2. ‘funds’ field in the ‘status’ block of the mother application shows ‘passed’ or equivalent when the transaction 0450 passes the funds check, and ‘failed’ or equivalent when the transaction 0450 fails the funds check. FIGS. 12-13 illustrate AAE1 journal lines as appropriately needed for the receipt scenarios 1.1 and 1.21 (1975 for receipt scenario 1.1 and 2075 for receipt scenario 1.21). FIGS. 14-16 illustrate AAE1 and AAE2 journal lines (AAE1: 2175, 2275 and 2375 and AAE2: 2185, 2285, and 2385) as appropriately needed for the receipt scenarios 1.22, 2.1 and 2.2 therein shown (2150, 2250 and 2350 respectively). invoice and prepayment scenarios comprise only AAE1. Normal receipt scenario 1.1 and exception receipt scenario 1.21 also have only AAE1. Exception receipt scenarios 1.22, 2.1 and 2.2 have both AAE1 and AAE2.

FIGS. 12-16 exemplarily illustrate screenshots displaying the journal entries generated by the system with the subject add-on controls, for example, 0470 and 0480 in place with details as to the exact nature and amount of the additional accounting effect or effects, and the journal lines corresponding to the invoice or receipt transaction and lines corresponding to the related AAE1, or AAE1 and AAE2. The status block of the journal window of the mother application shows success or failure in the funds check (1995, 2095, 2195, 2295, and 2395) and also shows the state of posting or not posting of the journal.

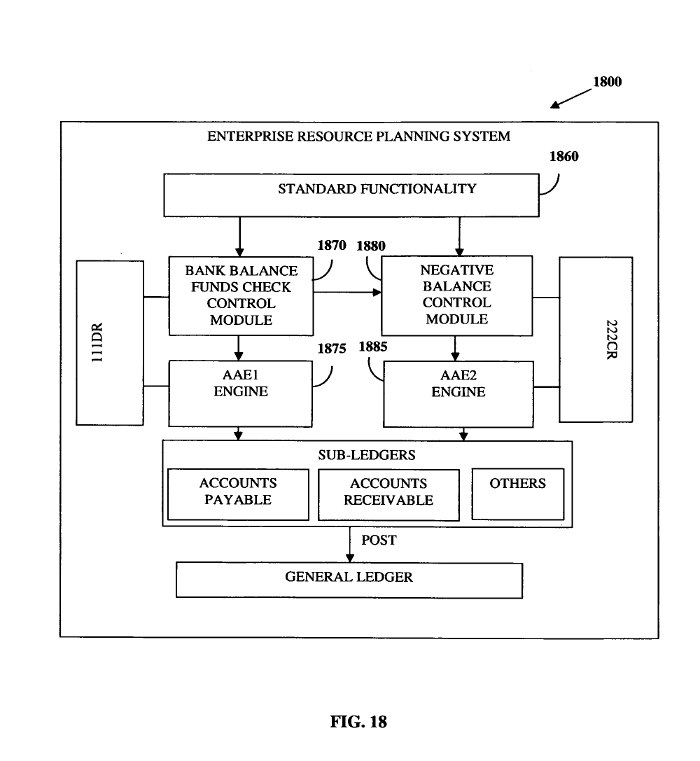

FIG. 18 exemplarily illustrates an enterprise resource planning (ERP) system 1800 for validating a financial transaction based on bank balance funds available in one or more bank accounts. The ERP system 1800 comprises the ERP standard functionality 1860, in addition to which new add-on controls, namely, a bank balance funds check (BBFC) control module 1870 and a negative balance control module 1880 are integrated to the ERP system 1800, with additional accounting effect engines, namely, AAE1 engine 1875 and AAE2 engine 1885. The bank balance funds check (BBFC) control module 1870 determines the bank balance funds available in one or more bank accounts, on request for conducting a financial transaction. The financial transaction comprises, for example, processing one of a journal, an invoice, a positive receipt, and a negative receipt. The BBFC control module 1870 validates the financial transaction if the bank balance funds available (BBFA) is adequate for conducting the financial transaction. The BBFC control module 1870 prevents validation of the financial transaction if the bank balance funds available (BBFA) is inadequate for conducting the financial transaction. The negative balance control module 1880 validates the financial transaction irrespective of the bank balance funds available (BBFA) being inadequate for processing a receipt, if the financial transaction comprises processing one of a positive receipt and a negative receipt. The AAE1 engine 1875 generates the additional accounting effect 1 (AAE1) when an appropriate transaction code is referenced in the user transaction (used in combination with AAE2 for processing of receipts). The AAE2 engine 1885 generates the additional accounting effect 2 (AAE2) which is used to allow processing of receipts and manage the situation arising there out of even when they result in negative bank balance funds deficit (BBFD) or increase the existing negative bank balance funds deficit (BBFD).

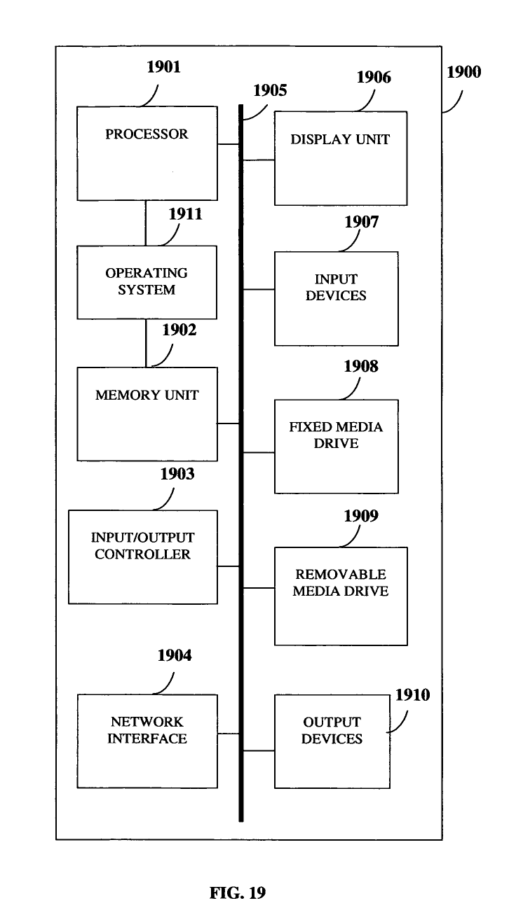

FIG. 19 exemplarily illustrates the architecture of a computer system or a server system 1900 employed for an enterprise resource planning (ERP) system 1800 for validating a financial transaction based on bank balance funds available in one or more bank accounts. An enterprise resource planning system package 1800 comprising the standard functionality 1860 and the subject add-on controls 1870 and 1880 is installed on the server system 1900. The server system 1900 comprises, for example, a processor 1901, a memory unit 1902 for storing programs and data, an input/output (I/O) controller 1903, a network interface 1904, a data bus 1905, a display unit 1906, input devices 1907, output devices 1910, or any subset or superset of components thereof.

The processor 1901 is an electronic circuit that executes computer programs. The memory unit 1902 stores programs, applications, and data. The memory unit 1902 is, for example, a random access memory (RAM) or another type of dynamic storage device that stores information and instructions for execution by the processor 1901. The memory unit 1902 also stores temporary variables and other intermediate information used during execution of the instructions by the processor 1901. The server system 1900 further comprises a read only memory (ROM) or another type of static storage device that stores static information and instructions for the processor 1901. The network interface 1904 enables connection of the server system 1900 to a network. The network is, for example, a local area network (LAN), a wide area network, a mobile communication network, etc. The server system 1900 of the ERP system 1800 communicates, for example, with client devices through the network interface 1904. The network interface 1904 comprises, for example, a universal serial bus interface (USB), a local area network (LAN), a wide area network (WAN) interface, etc. The I/O controller 1903 controls the input and output actions performed, for example, by end users or administrators of the ERP system 1800. The data bus 1905 permits communication between the modules, for example, 1860, 1870, 1880, 1875, and 1885 of the ERP system 1800.

The display unit 1906 displays the actions computed by the enterprise resource planning (ERP) system 1800 to a user. The input devices 1907 are used for inputting data into the server system 1900. The input devices 1907 are, for example, a keyboard such as an alphanumeric keyboard, a joystick, a mouse, a touch pad, a light pen, etc. The output devices 1910 output the results of the actions computed by the ERP system 1800, for example, to the administrators and end users of the ERP system 1800.

The server system 1900 may further comprise a fixed media drive 1908 and a removable media drive 1909 for receiving removable media. Computer applications and programs are used for operating the server system 1900. The programs may be loaded onto the fixed media drive 1908 and into the memory unit 1902 of the server system 1900 via the removable media drive 1909. In an embodiment, the computer applications and programs may be loaded directly via a network. Computer applications and programs are executed by a user action like double clicking a related icon displayed on the display unit 1906 using one of the input devices 1907. The users and the administrators interact with the server system 1900 of the ERP system 1800 using a user interface.

The server system 1900 of the ERP system 1800 employs an operating system 1911 for performing multiple tasks. The operating system 1911 is responsible for management and coordination of activities and sharing of resources of the server system 1900. The operating system 1911 further manages security of the server system 1900, peripheral devices connected to the server system 1900, and network connections. The operating system 1911 recognizes keyboard inputs and pointing device inputs of an administrator or a user, output display, files, and directories stored locally on the fixed media drive 1908. The operating system 1911 on the server system 1900 executes different programs, for example, a web browser, an electronic mail (email) application, etc., initiated by the administrators or users of the ERP system 1800 using the processor 1901. The operating system 1911 monitors the use of the processor 1901. The processor 1901 retrieves the instructions for executing the modules, for example, bank balance funds check control module 1870, negative balance control module 1880, AAE1 Engine 1875, and AAE2 Engine 1885 of the ERP system 1800 from the program memory in the form of signals. A program counter determines the location of the instructions in the program memory. The program counter stores a number that identifies the current position in the program of the modules, for example, 1870, 1880, 1875, and 1885 of the ERP system 1800.

The instructions fetched by the processor 1901 from the program memory after being processed are decoded. The instructions are placed in an instruction register (IR) in the processor 1901. After processing and decoding, the processor 1901 executes the instructions. For example, the BBFC control module 1870 defines instructions for determining the bank balance funds available in one or more bank accounts, on request for conducting a financial transaction, and for validating the financial transaction, if the bank balance funds available (BBFA) is adequate for conducting the financial transaction. The BBFC control module 1870 defines instructions for preventing validation of the financial transaction, if the bank balance funds available (BBFA) is inadequate for conducting the financial transaction. The negative balance control module 1880 defines instructions for validating the financial transaction irrespective of the bank balance funds available (BBFA) being inadequate for processing a receipt, if the financial transaction comprises processing one of a positive receipt and a negative receipt. The AAE1 engine 1875 defines instructions for generating the additional accounting effect 1 (AAE1) when an appropriate transaction code is referenced in the user transaction (used in combination with AAE2 for processing of receipts). The AAE2 engine 1885 defines instructions for generating the additional accounting effect 2 (AAE2) which is used to allow processing of receipts and manage the situation arising there out of even when they result in negative bank balance funds deficit (BBFD) or increase the existing negative bank balance funds deficit (BBFD).

The processor 1901 of the server system 1900 retrieves the instructions defined by the BBFC control module 1870, the negative balance control module 1880, the AAE1 engine 1875, and the AAE2 engine 1885, and executes the instructions.

At the time of execution, the instructions stored in the instruction register are examined to determine the operations to be performed. The operations include arithmetic and logic operations. The processor 1901 then performs the specified operation. The operating system 1911 performs multiple routines for performing a number of tasks required to assign the input devices 1907, the output devices 1910, and memory for the execution of the modules, for example, 1870, 1880, 1875, and 1885 of the ERP system 1800. The tasks performed by the operating system 1911 comprise assigning memory to the modules, for example, 1870, 1880, 1875, and 1885 of the ERP system 1800, moving data between the memory unit 1902 and disk units and handling input/output operations, etc. The operating system 1911 performs the tasks on request by the operations and after performing the tasks, the operating system 1911 transfers the execution control back to the processor 1901. The processor 1901 continues the execution to obtain one or more outputs. The outputs of the execution of the modules, for example, 1870, 1880, 1875, and 1885 of the ERP system 1800 are displayed, for example, to the administrator or end users of the ERP system 1800.

Disclosed herein also is a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 1901, except for a transitory, propagating signal.

The computer program product disclosed herein comprises one or more computer program codes for validating financial transactions performed through an enterprise resource planning system 1800, by providing multiple controls 1870 and 1880 to the enterprise resource planning system 1800. For example, the computer program product disclosed herein comprises a first computer program code for creating a first additional account and a second additional account, wherein the first additional account and the second additional account is associated with the enterprise resource planning system 1800, a second computer program code for attaching each of the first and second additional accounts with one or more transaction codes for automatically referencing for conducting the financial transaction, a third computer program code for providing a bank balance funds check control 0470 and 0570 and a negative balance control 0480 and 0580, a fourth computer program code for integrating the bank balance funds check control 0470 and 0570 into the enterprise resource planning system 1800, a fifth computer program code for integrating the negative balance control 0480 and 0580 into the enterprise resource planning system 1800, a sixth computer program code for controlling the financial transaction by the bank balance funds check control 0470 and 0570 and/or the negative balance control 0480 and 0580, a seventh computer program code for referencing one of the transaction codes and validating the financial transaction by the bank balance funds check control 0470 and 0570, if the bank balance funds available is adequate for conducting the financial transaction, and an eighth computer program code for referencing one of the transaction codes and validating the financial transaction by the negative balance control 0480 and 0580, if the financial transaction comprises processing one of the positive receipt and the negative receipt.

The computer program codes comprising the computer executable instructions for validating financial transactions performed through an enterprise resource planning system 1800 are embodied on the non-transitory computer readable storage medium. The processor 1901 of the computer system 1900 retrieves these computer executable instructions and executes them. When the computer executable instructions are executed by the processor 1901, the computer executable instructions cause the processor 1901 to perform the method steps for validating financial transactions performed through an enterprise resource planning system 1800, by providing multiple controls to the enterprise resource planning system 1800. In an embodiment, a single piece of computer program code comprising computer executable instructions performs one or more steps of the computer implemented method disclosed herein for validating financial transactions performed through an enterprise resource planning system 1800.

Bank balance funds check control 0470 and 0570 and negative balance control 0480 and 0580 as applicable to credit and prepaid situations

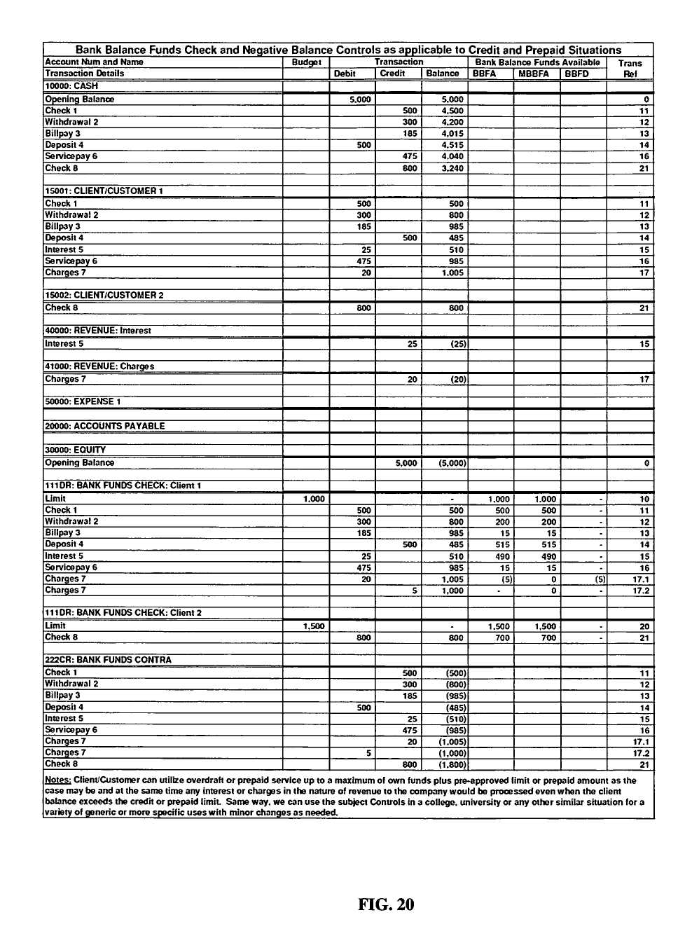

In an embodiment of the method and system disclosed herein, the subject controls, for example, 0470 and 0480 can be used in credit and prepaid situations, wherein, a pre-authorized credit limit or prepaid amount (called limit for purposes herein) can be set up, by way of entering such limit, instead of $0, as budget for the 111DR account and the additional accounting effect 1 or effects 1 and 2, as hereunto described with reference to FIG. 5A, to allow the client/customer to use the credit or prepaid service up to a maximum of own funds and the limit. Any transaction in the nature of the client/customer using the credit or service beyond the combined total of own funds and the limit will fail the validation, and at the same time, any interest or service charges that the service provider may charge, in the nature of revenue to the service provider, will be processed even when such transaction results in or increases usage over and beyond the own funds and the limit, as the case may be. The subject controls, for example, 0470 and 0480 can also be used in a variety of similar situations, in generic or more specific or applied ways, for similar end-purposes with or without minor changes. FIG. 20 exemplarily illustrates the implementation and results of the subject controls, for example, 0470 and 0480 in credit and prepaid situations, allowing the client/customer to use credit or service, at any time, up to a maximum of own funds plus the limit. The amount of the limit is entered as budget for the 111DR account (trans. ref. 10 for client 1 and trans. ref. 20 from client 2), instead of $0 (mentioned above). It is to be noted here that had the Service pay 6 been any amount in excess of $490, instead of $475, that transaction would have failed validation (trans. ref. 16). It is also to be noted that while charges 7 needs both AAE1 and AAE2 (trans. ref. 17.1 and 17.2), all other transactions shown in FIG. 20 need only AAE1. The charges 7 transaction (Trans. Ref. 17) of $20 is processed even though the existing bank balance funds available of $5 is inadequate for the transaction and results in negative bank balance funds available. It is to be noted that trans. ref. 17 would have failed validation had the transaction been a transaction of client/customer using credit or service instead of being a service charge charged by the service provider.

Certain matters in relation to the subject matter are sub-judice, and information in this regard will be submitted, as and when the patent office may require.

Apart from the purpose for which the controls, for example, 0470 and 0480 have been developed, the controls, for example, 0470 and 0480 can be used in many more ways. Apart from the bank example explained, financial services for example, banks and credit card companies can use controls, for example, 0470 and 0480 based on similar subject matter principles to prevent clients from borrowing in excess of their limits. A variety of prepaid businesses use or can use similar controls to prevent using the service beyond the abovementioned limit. Schools, colleges, universities and a variety of organizations can use similar controls, with minor modifications, as needed, to suit their specific requirements, for a variety of similar objectives. More complex concepts like an overall limit with sub-limits or security variations can also be implemented. While these are some of the uses that the applicant can readily think of, there could be many other ways of using the controls, for example, 0470 and 0480 in either generic or more specific ways. In brief, the subject controls, for example, 0470 and 0480 will find use, with or without modifications, in all the ERP systems, Oracle, and non-Oracle, as well as in a variety of other work situations, where needs that are similar or can be considered similar, directly or indirectly, exist or get to exist, in terms of underlying fundamental subject matter concepts, through conscious efforts like value added reengineering in ways that can lead to more efficient work processes, in terms of prevention of risks, better compliance and substantial reduction of costs; in short, a much enhanced utility and overall productivity.

As is normally the case in any software development or implementation, the same objective can usually be achieved in more than one way. It would depend on factors like the requirements and work environment, whether the development is a totally new system or some add-on features on top of an existing system, and in the latter case, it could also depend on how the base system is designed and built. It will also depend on the approach a particular developer or implementer or inventor uses to visualize, design and build the required features. The subject controls, for example, 0470 and 0480 have been developed through a combination of financial, accounting and information systems development principles, to achieve the objectives, based on considerations including process and productivity improvements, workplace efficiencies, prevention of risks, regulatory compliance and cost effectiveness.

Based on the experience and understanding of the market, the applicant believes that many user organizations can and will benefit from the subject controls, for example, 0470 and 0480, and as such, there is very good commercial potential. Since the subject of this application is the add-on controls, for example, 0470 and 0480 that enhance the standard functionality of an underlying ERP system, the subject high value added controls, for example, 0470 and 0480 may be integrated as part of the standard application suites, following the usual ERP principles of standardization, flexibility and universal usefulness, in a way they provide enhanced value addition to users across a wide spectrum of sectors, and market as an optional, independent, add-on module, targeting medium and large user organizations that need such additional functionality, at an additional cost. Marketing the controls, for example, 0470 and 0480 as a stand-alone product for the same purpose is another option.

While the underlying fundamental subject matter principles are the same in relation to all ERP systems, how the computer implemented method and system disclosed herein is developed, and how exactly the additional accounting effects are entered or referenced and controls, for example, 0470 and 0480 ensured could differ based on many factors including how the underlying base system is designed and built and the approach the particular implementer follows. The subject controls, for example, 0470 and 0480 have the potential to reduce the annual recurring costs substantially, apart from preventing the risks of not having them.

The computer implemented method and system disclosed herein puts together the underlying financial and accounting concepts (raw materials) into the subject bank balance funds check control 0470 and 0570 and the negative balance control 0480 and 0580 for ERP systems, creates enhanced value addition to the users and achieves the intended high value added objectives. The computer implemented method and system disclosed herein provides an improved functionality, process or business method that creates enhanced value addition to the user community. The value addition comes from the new improved process that puts together the underlying financial and accounting concepts (raw materials), in a way that would achieve the intended high value added objectives.

Some of the leading ERP products worldwide that the subject controls, for example, 0470 and 0480 may be integrated with include, for example, the Oracle® E-Business Suite, PeopleSoft, JD Edwards®, SAP®, Baan and Great Plains. Oracle® E-Business Suite, PeopleSoft® and JD Edwards® are owned by Oracle Corporation headquartered in Redwood shores, Calif., USA, SAP by SAP AG headquartered at Walldorf, Germany, Baan by Infor headquartered at Alpharetta, Ga., USA, and Great Plains by Microsoft Corp headquartered at Redmond, Wash., USA. The Oracle E-Business Suite is popularly called Oracle Financials. There are also a host of other ERP products, meeting the needs of different segments of the market.

Definition of terminologies used:

Bank balance funds available: bank balance funds available can either be combined uncommitted balance available in a single bank account or multiple applicable general purpose bank accounts.

Transaction code: Account code pair or transaction code used to create additional accounting effects. Transaction codes are standard features of most of the enterprise resource planning systems.

Combined bank balance: Total of actual balances of all applicable general purpose bank accounts, namely, savings, checking 1, checking 2, etc.

Bank balance funds deficit: Bank balance funds deficit or existing funds deficit is the negative bank balance funds available.

111DR funds available: This is the amount currently available up to which new commitments (reservations) against funds can be made (like for invoice payment). The subject controls, for example, 0470 and 0470 maintain this always equal to or greater than $0.

Funds reserved: Funds reserved on some transaction or transactions (like invoice), pending full processing (like payment), if any, irrespective of what intermediate stage the transaction is in (like encumbrance or liability).

Funds deficit: Total or net funds deficit on account of combined bank balance and funds reserved.

It will be readily apparent that the various methods and algorithms disclosed herein may be implemented using computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for validating financial transactions performed through an enterprise resource planning system, by providing a plurality of controls to said enterprise resource planning system, comprising:
creating a first additional account and a second additional account, wherein said first additional account and said second additional account are associated with said enterprise resource planning system;
attaching each of said first and second additional accounts with one or more transaction codes for automatically referencing for conducting said financial transaction;
providing a bank balance funds check control and a negative balance control;
integrating said bank balance funds check control into said enterprise resource planning system, wherein said bank balance funds check control determines bank balance funds available in one or more bank accounts and controls said financial transaction based on said bank balance funds available, and wherein said bank balance funds check control allows said financial transaction, if said bank balance funds available is adequate for conducting said financial transaction, thereby preventing negative bank funds in said one or more bank accounts resulting out of said financial transaction, and wherein said financial transaction comprises processing one of a journal, an invoice, a positive receipt, and a negative receipt;
integrating said negative balance control into said enterprise resource planning system for controlling said financial transaction, wherein said negative balance control monitors type of said financial transaction and allows conducting of said financial transaction, irrespective of said bank balance funds available being inadequate for conducting said financial transaction;
controlling said financial transaction by one or more of said bank balance funds check control and said negative balance control, comprising:
referencing one of said one or more transaction codes and validating said financial transaction by said bank balance funds check control, if said bank balance funds available is adequate for conducting said financial transaction; and
referencing one of said one or more transaction codes and validating said financial transaction by said negative balance control, if said financial transaction comprises processing one of one or more of said positive receipt and said negative receipt.

2. The computer implemented method of claim 1, wherein said bank balance funds check control prevents validation of said financial transaction, if said bank balance funds available is inadequate for conducting said financial transaction, and wherein said negative balance control provides context-sensitive exceptions to said bank balance funds check control for validating said financial transaction, if said financial transaction comprises processing one of a positive receipt and a negative receipt.

3. The computer implemented method of claim 1, wherein said bank balance funds available for conducting said financial transaction is the combined balance available in said one or more bank accounts for conducting said financial transaction, excluding funds reserved and unavailable for conducting said financial transaction.

4. The computer implemented method of claim 1, wherein said one or more bank accounts comprise one or more designated accounts for processing payment for said invoice, and wherein said invoice is processed irrespective of availability of sufficient balance in said designated account, if said bank balance funds available is adequate for processing said payment for said invoice.

5. The computer implemented method of claim 1, wherein said financial transaction involves processing one of one or more of an accounts payable, an accounts receivable, and ledger entries.

6. The computer implemented method of claim 1, wherein said controlling of said financial transaction by said bank balance funds check control and said negative balance control comprises:
defining a first additional accounting effect for validating said financial transaction; and
defining a second additional accounting effect for validating said positive and negative receipts.

7. The computer implemented method of claim 1, wherein said negative balance control utilizes context sensitive exceptions for validating said positive and negative receipts, and wherein said context sensitive exceptions comprise:
validating one of said positive receipt and said negative receipt, if said bank balance funds available is positive; and
validating one of said positive receipt and said negative receipt, if said bank balance funds available is negative or zero.

8. The computer implemented method of claim 1, further comprising:
processing said validated financial transaction; and
posting said processed financial transaction into general ledger.

9. The computer implemented method of claim 1, wherein said creating said first additional account comprises:
initializing budget of said first additional account to zero; and
defining funds check level to absolute for said first additional account.

10. The computer implemented method of claim 1, wherein said bank balance funds check control is implemented as a standalone control for validating said financial transaction.

11. The computer implemented method of claim 6, wherein a payment transaction code is referenced when a distribution account is an expense account and a receipt transaction code is referenced when said distribution account is a revenue account for validating said invoice, and wherein said first additional accounting effect debits said first additional account and credits said second additional account by amount of said invoice.

12. The computer implemented method of claim 6, wherein a receipt transaction code is referenced for validating said positive receipt, and wherein said first additional accounting effect credits said first additional account and debits said second additional account by amount of said positive receipt.

13. The computer implemented method of claim 6, wherein a receipt transaction code is referenced for validating said negative receipt, and wherein said first additional accounting effect credits said second additional account and debits said first additional account by amount of said negative receipt.

14. The computer implemented method of claim 6, wherein for processing said negative receipt, said negative balance control allows said second additional accounting effect to credit said first additional account and debit said second additional account by an amount equal to the difference between amount of said negative receipt and amount of said bank balance funds available, if said existing bank balance funds available is positive and said amount of said negative receipt is greater than said amount of said bank balance funds available.

15. The computer implemented method of claim 6, wherein for processing said negative receipt, said negative balance control allows said second additional accounting effect to credit said first additional account and debit said second additional account by an amount equal to amount of said negative receipt, if said bank balance funds available is equal to zero or negative.

16. The computer implemented method of claim 6, wherein for processing a positive receipt, said negative balance controls allows said second additional accounting effect to debit said first additional account and credit said second additional account by an amount, and wherein said amount is equal to least of the amount of positive receipt and amount of bank balance funds deficit, if said bank balance funds available is equal to zero or negative, and wherein said bank balance funds deficit is negative bank balance funds available.

17. The computer implemented method of claim 1, further comprising applying said bank balance funds check control and said negative balance control for credit and prepaid situations, comprising:
entering a preauthorized limit in addition to said additional accounting effects, wherein said bank balance funds check control and said negative balance control allows a customer to use credit or prepaid service up to a maximum of said bank balance funds and said preauthorized limit, whereby a transaction in the nature of said customer using said funds or service beyond a combined total of said bank balance funds and said preauthorized limit fails validation, and at the same time, any interest or charges of a service provider is processed even when said transaction results in or increases usage in said bank balance funds available in one or more bank accounts over and beyond said bank balance funds plus said preauthorized limit.

18. A computer implemented control system for an enterprise resource planning system for validating a financial transaction based on bank balance funds available in one or more bank accounts associated with said enterprise resource planning system, said control system, comprising one or more of:
a bank balance funds check control module integrated with said enterprise resource planning system, wherein said bank balance funds check control performs:
determining said bank balance funds available in said one or more bank accounts, on request for conducting said financial transaction, wherein said financial transaction comprises processing one of a journal, an invoice, a positive receipt, and a negative receipt;
validating said financial transaction, if said bank balance funds available is adequate for conducting said financial transaction;
preventing validation of said financial transaction, if said bank balance funds available is inadequate for conducting said financial transaction; and
a negative balance control module integrated with said enterprise resource planning system, wherein said negative balance control module monitors type of said financial transaction and validates said financial transaction irrespective of said bank balance funds available being inadequate, if said financial transaction comprises processing one of a positive receipt and a negative receipt.

19. A computer program product comprising computer executable instructions embodied in a non-transitory computer readable storage medium, wherein said computer program product comprises:
a first computer program code for creating a first additional account and a second additional account, wherein said first additional account and said second additional account are associated with an enterprise resource planning system;
a second computer program code for attaching each of said first and second additional accounts with one or more transaction codes for automatically referencing for conducting said financial transaction;
a third computer program code for providing a bank balance funds check control and a negative balance control;
a fourth computer program code for integrating said bank balance funds check control into said enterprise resource planning system, wherein said bank balance funds check control determines bank balance funds available in one or more bank accounts and controls said financial transaction based on said bank balance funds available, and wherein said bank balance funds check control allows said financial transaction, if said bank balance funds available is adequate for conducting said financial transaction, thereby preventing negative bank funds in said one or more bank accounts resulting out of said financial transaction, and wherein said financial transaction comprises processing one of a journal, an invoice, a positive receipt, and a negative receipt;
a fifth computer program code for integrating said negative balance control into said enterprise resource planning system for controlling said financial transaction, wherein said negative balance control monitors type of said financial transaction and allows conducting of said financial transaction, irrespective of said bank balance funds available being inadequate for conducting said financial transaction;
a sixth computer program code for controlling said financial transaction by one or more of said bank balance funds check control and said negative balance control, comprising:
a seventh computer program code for referencing one of said one or more transaction codes and validating said financial transaction by said bank balance funds check control, if said bank balance funds available is adequate for conducting said financial transaction; and
an eighth computer program code for referencing one of said one or more transaction codes and validating said financial transaction by said negative balance control, if said financial transaction comprises processing one of one or more of said positive receipt and said negative receipt.
